(19) United States
(12) Patent Application Publication
(10) Pub. No.: US 2024/0251367 A1
(43) Pub. Date: Jul. 25, 2024

(54) METHOD FOR RECEIVING COMMON SIGNAL, METHOD FOR TRANSMITTING COMMON SIGNAL AND APPARATUSES THEREFOR AND COMMUNICATION SYSTEM

(71) Applicant: FUJITSU LIMITED, Kawasaki-shi Kanagawa (JP)

(72) Inventor: Yang LU, Beijing (CN)

(73) Assignee: FUJITSU LIMITED, Kawasaki-shi Kanagawa (JP)

(21) Appl. No.: 18/626,708

(22) Filed: Apr. 4, 2024

Related U.S. Application Data
(63) Continuation of application No. PCT/CN2021/125448, filed on Oct. 21, 2021.

(51) Int. Cl. H04W 56/00

(52) U.S. Cl. CPC H04W 56/0015

(57) ABSTRACT

An apparatus for receiving a common signal, applicable to a terminal equipment includes processor circuitry configured to perform: receiving master information block (MIB) information and/or system information block (SIB) information of one or more second cells transmitted by a first cell; detecting a reference signal of the second cell; and obtaining synchronization with the second cell via the detected reference signal of the second cell.

### CROSS-REFERENCE TO RELATED APPLICATION

This application is a continuation application of International Application PCT/CN2021/125448, filed on Oct. 21, 2021, and designated the U.S., the entire contents of which are incorporated herein by reference.

### TECHNICAL FIELD

This disclosure relates to the field of communication technologies.

### BACKGROUND

As a New Radio (NR) base station needs to operate at a high bandwidth (e.g. 100 MHz), and a large number of ports (e.g. 64T/64R) and shorter transmission time interval (TTI) (e.g. 1 ms) are needed, power consumption overhead of the NR base station in such functions as baseband processing, and digital front end, etc. is significantly higher than that of a long term evolution (LTE) base station. Moreover, the FR2 operating frequency of NR (>6 GHz) is relatively high, and the higher the frequency point, the greater the signal path loss. Therefore, a design principle of NR is to use a narrower beam to make signals transmitted further. Hence, the number of antenna units used by the NR base station for analog beamforming will be greatly increased, leading to an increase in numbers of RF units and RF channels for transmitting and receiving signals. Each RF channel is provided with a power amplifier (PA), and power consumption of the PA will account for about 80% of the entire power consumption of the base station. As the number of PAs increases, the power consumption of the base station will also be increased. The current FR1 band AAU generally uses 192 antenna units and supports 64 channels, which are much larger than 8 channels of a maximum number of LTE.

According to data statistics of operators, average power consumption of an NR base station is more than three times that of an LTE base station, and nearly 50% of the cost for deploying 5G networks by operators is related to power expenses. More important, even during time periods when there is no service, the power consumption of the NR base station is still not low, because even when there is no service, the base station still needs to transmit some common signals, such as a synchronization signal block (SSB), a system information block (SIB) 1, and system information (SI), etc., which greatly reduces energy efficiency of the NR base station. Energy conservation in NR networks is an urgent issue that needs to be addressed.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY OF THE DISCLOSURE

In 3GPP Rel-15/Rel-16, a proposed solution for network energy saving of NR is to dynamically open and close an NR cell according to such information as amounts of traffics of the NR cell and its neighboring cells, and UE measurement reports, etc., and when the NR cell is closed, it enters an energy-saving state, thereby achieving a goal of closing the NR cell so as to save energies when the amount of traffic is relatively low. Whether NR enters the energy-saving state may be determined by the NR cell itself (a distributed network energy-saving scheme), or may be determined by OAM (centralized network energy-saving scheme). For example, when the amount of traffic of the NR cell falls below a certain threshold, it is determined that the cell enters the energy-saving state.

In the distributed network energy-saving scheme, when the NR cell enters the energy-saving state, the base station makes the UE to hand over to a neighboring cell and informs the neighboring NR or an LTE base station that the NR cell has entered the energy-saving state. The neighboring NR/LTE base station will bear the coverage area and the amount of traffic of the NR cell. Thereafter, the neighboring NR/LTE base stations will determine whether to request the NR cell that has entered the energy-saving state to resume normal operations according to their own amounts of traffics, and UE measurement reports, etc. For example, when their amounts of traffics reach a certain threshold, request for the NR cell that has entered the energy-saving state to resume normal operations will be triggered. When the NR cell resumes normal operations, some UEs that previously handed over to neighboring NR/LTE cells may hand over back to the NR cell.

It was found by the inventors of this disclosure that in existing techniques, if the NR cell enters an energy-saving state, it means that the cell stops receiving and transmitting all signals. Therefore, the UE originally connected to the cell must hand over to another cell, and the UE originally camping on the cell will perform cell reselection; in order to achieve inter-cell load balancing, according to the amount of traffic of the NR cell and its neighboring cells, the NR cell will dynamically enter an energy-saving state multiple times, and a terminal equipment (such as a UE) will frequently hand over out of the NR cell or perform cell reselection frequently, which will affect user experiences. In entering the energy-saving state, as transmission and reception of signals may be stopped, in order to save power, the NR cell may directly close RF processing units. When normal operations resumed, the RF processing units need to be reopened. However, opening the RF units requires a certain time interval, which makes it difficult for a UE connected to or camping on another cell to hand over or camp on that cell in a timely manner, or the UE is unable to initiate services in that cell. Thus, when normal operations are resumed, service interruption will be caused and user experiences will be affected.

In order to solve at least one of the above problems, embodiments of this disclosure provide a method for receiving a common signal, a method for transmitting a common signal and apparatuses therefor and a communication system, in which a terminal equipment receives master information block information and/or system information block information of a second cell from a first cell, and receives a reference signal of the second cell from the second cell. Thus, the terminal equipment may keep synchronization with the second cell and acquire the master information block information and/or system information block information of the second cell, thereby ensuring that the UE is able to normally camp on the second cell 1B when the second cell 1B enters the energy-saving state, and initiate services in the second cell or keep downlink synchronization with the second cell, thereby avoiding service interruption.

According to an aspect of the embodiments of this disclosure, there is provided an apparatus for receiving a common signal, applicable to a terminal equipment, the apparatus including a first processing unit configured to perform the following operations:
receiving master information block (MIB) information and/or system information block (SIB) information of one or more second cells transmitted by a first cell;
detecting a reference signal of the second cell; and
obtaining synchronization with the second cell via the detected reference signal of the second cell.

According to another aspect of the embodiments of this disclosure, there is provided an apparatus for transmitting a common signal, applicable to a network device to which a first cell belongs, the apparatus including a second processing unit configured to perform the following operations:
transmitting master information block (MIB) information and/or system information block (SIB) information of one or more second cells by a first cell to a terminal equipment,
wherein when a reference signal of the second cell is detected, the terminal equipment obtains synchronization with the second cell according to the reference signal of the second cell.

According to a further aspect of the embodiments of this disclosure, there is provided an apparatus for transmitting a common signal, applicable to a network device to which a second cell belongs, the apparatus including a third processing unit configured to perform the following operations:
transmitting a reference signal of a second cell to a terminal equipment via the second cell,
wherein the terminal equipment further receives master information block (MIB) information and/or system information block (SIB) information of the second cell transmitted by a first cell, and obtains synchronization with the second cell according to the detected reference signal of the second cell.

An advantage of the embodiments of this disclosure exists in that the terminal equipment receives the master information block information and/or system information block information of the second cell from the first cell, and receives the reference signal of the second cell from the second cell. Thus, the terminal equipment may keep synchronization with the second cell and acquire the master information block information and/or system information block information of the second cell, thereby ensuring that the UE is able to normally camp on the second cell 1B when the second cell 1B enters the energy-saving state, and initiate services in the second cell or keep downlink synchronization with the second cell, thereby avoiding service interruption.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a terminal equipment, a first cell and a second cell;

FIG. 2 is a schematic diagram of a method for receiving a common signal of an embodiment of a first aspect of this disclosure;

FIG. 3 is a schematic diagram of a reference signal of the second cell;

FIG. 4 is a schematic diagram of a synchronization relationship between the first cell and the second cell;

FIG. 5 is another schematic diagram of the synchronization relationship between the first cell and the second cell;

FIG. 6 is a schematic diagram of the reference signal and a PBCH payload;

FIG. 7 is another schematic diagram of the reference signal and the PBCH payload;

FIG. 8 is a schematic diagram of a method for transmitting a common signal of an embodiment of a second aspect of this disclosure;

FIG. 9 is a schematic diagram of a method for transmitting a common signal of an embodiment of a third aspect of this disclosure;

FIG. 10 is a schematic diagram of an apparatus for receiving of an embodiment of a fourth aspect of this disclosure;

FIG. 11 is a schematic diagram of an apparatus for transmitting of an embodiment of a fifth aspect of this disclosure;

FIG. 12 is a schematic diagram of an apparatus for transmitting of an embodiment of a sixth aspect of this disclosure;

FIG. 13 is a schematic diagram of a terminal equipment of an embodiment of a seventh aspect of this disclosure; and

FIG. 14 is a schematic diagram of a network device of the embodiment of the seventh aspect of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G and 5G and new radio (NR) in the future, etc., and/or other communication protocols that are currently known or will be developed in the future.

In the embodiments of this disclosure, the term “network device”, for example, refers to a device in a communication system that accesses a terminal equipment to the communication network and provides services for the terminal equipment. The network device may include but not limited to the following equipment: an integrated access and return node (IAB-node), a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or a core network device, and may include one or more network devices described above. The term “user side” or “terminal side” or “terminal equipment side” refers to a side of a user or a terminal, which may be a UE, and may include one or more terminal equipments described above. “Device” may refer to a network device, or may refer to a terminal equipment.

Without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUSCH, transmitting or receiving a PRACH may be understood as transmitting or receiving a preamble carried by the PRACH, and an uplink signal may include an uplink data signal and/or an uplink control signal, etc., and may also be referred to as uplink (UL) transmission or uplink information or an uplink channel. Transmitting uplink transmission on an uplink resource may be understood as transmitting the uplink transmission by using the uplink resource. Likewise, downlink data/signal/channel/information may be understood accordingly.

In the embodiments of this disclosure, higher-layer signaling may be, for example, radio resource control (RRC) signaling; for example, it is referred to an RRC message, which includes a master information block (MIB), system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

In the embodiments of this disclosure, an SSB may be referred to as a synchronization signal block, or, it may also be referred to as a synchronization signal (SS) and physical broadcast channel (PBCH) block.

### Embodiment of a First Aspect

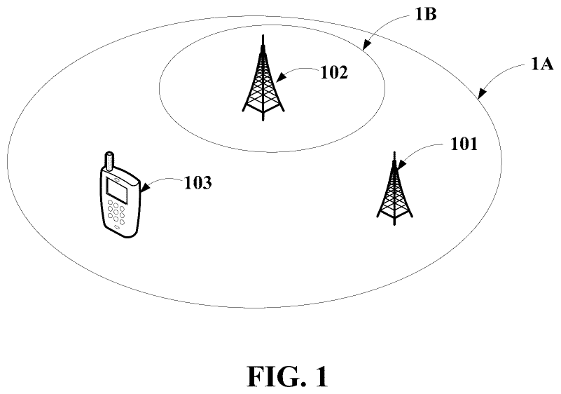

FIG. 1 is schematic diagram of a terminal equipment, a first cell and a second cell. As shown in FIG. 1, a network device 101 is a network device to which first cell 1A belongs, a network device 102 is a network device to which a second cell 1B belongs, a terminal equipment 103 is within the first cell.

In FIG. 1, a coverage range of the second cell 1B is within coverage range of the first cell 1A; however, this disclosure is not limited thereto. A coverage range of the second cell may also be outside the coverage range of the first cell, or the coverage range of the second cell partially overlaps with that of the first cell. For example, the first cell 1A is deployed around the second cell 1B, and the first cell 1A is a neighboring cell to the second cell 1B.

In FIG. 1, one second cell 1B is shown; however, this disclosure is not limited thereto, and the number of the second cell 1B may be one or more.

In at least one embodiment, in a case where an amount of traffic of the second cell 1B is below a certain threshold or there is no serving terminal equipment (such as a UE), the second cell 1B may stop transmitting other broadcast signals and stop receiving signals, that is, the second cell 1B enters an energy-saving state, thereby saving energy consumption expenses of the network device 102, and improving the energy efficiency of the network device 102.

The embodiment of the first aspect of this disclosure provides a method for receiving a common signal, applicable to a terminal equipment, such as the terminal equipment 103.

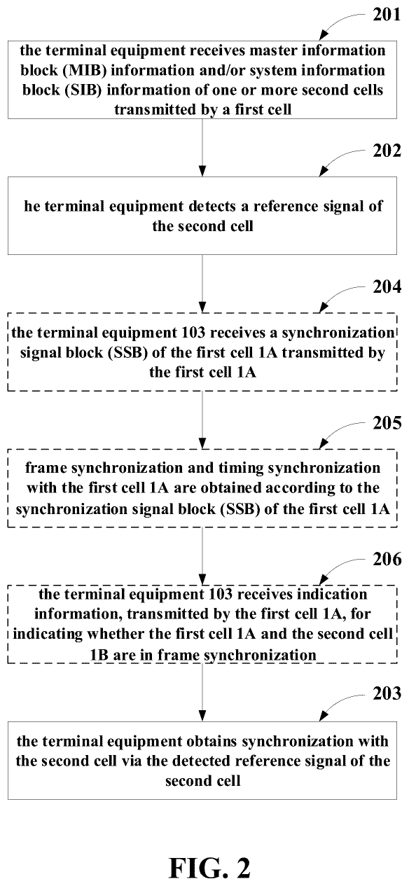

FIG. 2 is a schematic diagram of the method for receiving a common signal of the embodiment of the first aspect of this disclosure. As show in FIG. 2, the method includes:
operation 201: the terminal equipment receives master information block (MIB) information and/or system information block (SIB) information of one or more second cells transmitted by a first cell;
operation 202: the terminal equipment detects a reference signal of the second cell; and
operation 203: the terminal equipment obtains synchronization with the second cell via the detected reference signal of the second cell.

According to the embodiment of the first aspect of this disclosure, the terminal equipment 103 receives the master information block information and/or system information block information of the second cell 1B from the first cell 1A, and receives the reference signal of the second cell 1B from the second cell 1B. Therefore, the terminal equipment 103 is able to keep synchronization with the second cell and obtain the master information block information and/or system information block information of the second cell 1B, thereby ensuring that the UE is able to normally camp on the second cell 1B when the second cell 1B enters the energy-saving state, initiating services in the second cell 1B or keeping downlink synchronization with the second cell 1B, and avoiding service interruption.

In at least one embodiment, the master information block information of the second cell 1B includes at least one of the following: a cell barring ID, such as cellBarred; an intra-frequency cell reselection ID (intraFreqReselection); a subcarrier spacing for SIB1, msg2/4 and system information (subCarrierSpacingCommon for SIB1, msg 2/4 and SI); or position information of a demodulation reference signal (DMRS) (dmrs-TypeA-Position). And furthermore, it may include other information.

In some embodiments, the system information block (SIB) specifically refers to system information block 1 (SIB1).

In at least one embodiment, the system information block (SIB) information of the second cell 1B includes at least one of the following:
cell selection information, including information on signal receiving power or signal receiving quality used for cell selection;
cell access information, including public land mobile network (PLMN) list information supported by the cell, a tracking area (TAC), and a cell identifier;
system information (SI) scheduling information, including an SI window length, SIB types included in SI, SI broadcast state (i.e. whether SI is broadcast), and SI request configuration information; or
access information based on a service category, such as access control related information related to different service categories and access levels of the UE, including barring indication information for different service categories and levels initiated by the UE.

In addition, other information may also be included.

Therefore, by obtaining, from the first cell, the cell barring ID and intra-frequency cell reselection ID of the second cell, the UE may successfully camp on the second cell. By obtaining, from the first cell, access information based on category of the second cell, the UE may initiate services in the second cell. The cell selection information of the second cell obtained by the first cell enables the UE to perform cell selection and reselection in the second cell. And by obtaining the SI scheduling information of the second cell from the first cell, the UE may receive the system information in the second cell or request the second cell to transmit SI needed by the UE.

The method for receiving a common signal in the embodiment of the first aspect of this disclosure shall be described below with reference to different implementations.

### Implementation 1

In Implementation 1, the second cell 1B does not transmit a PBCH payload (physical layer information), MIB (RRC message) and SIB1, but transmits a reference signal.

What are originally carried in the PBCH payload are low 4 bits of an SFN, a half-frame indicator and an SSB index, all of which are information related to frame synchronization and timing synchronization. High 6 bits of an SFN are transmitted in the MIB. If the information of the second cell 1B is not transmitted in the second cell 1B, synchronization with the second cell is unable to be obtained in existing techniques. In Implementation 1, the UE obtains synchronization with the second cell 1B by synchronizing with the first cell 1A.

Specifically, the UE may first obtain frame synchronization and timing synchronization with the first cell 1A, and then obtain synchronization with the second cell 1B through the frame synchronization information of the first cell 1A and synchronization with the first cell 1A.

As shown in FIG. 2, Implementation 1 includes operations 201, 202, 203, 204, 205 and 206.

In operation 201, the terminal equipment receives the master information block (MIB) information and/or system information block (SIB) information of the second cell transmitted by the first cell.

If the terminal equipments in an idle state or inactive state is to select and camp on the second cell 1B, it needs to obtain the master information block (MIB) information and/or system information block (SIB) information of the second cell 1B in addition to obtaining synchronization of the second cell 1B.

In at least one embodiment, the master information block (MIB) information and/or system information block (SIB) information of the second cell 1B is/are carried by a system broadcast message of the first cell 1A, such as by SIB1 of the first cell 1A. In one example, the terminal equipment 103 may receive master information block (MIB) information and/or system information block (SIB) information of one or more second cells from the system broadcast message of the first cell 1A, thereby enabling the terminal equipment to select and camp on the second cell. In addition, the terminal equipment 103 may save the master information block (MIB) information and/or system information block (SIB) information of one or more second cells 1B in a buffer, so that it may camp on the second cell 1B after detecting the reference signal of the second cell 1B and synchronizing therewith.

In at least one embodiment, after the terminal equipment obtains synchronization with the second cell 1B, it may determine whether the master information block (MIB) information and/or system information block (SIB) information of the second cell 1B is/are saved. If the terminal equipment 103 determines that the master information block (MIB) information and/or system information block (SIB) information of the second cell 1B is/are saved, the terminal equipment 103 may camp on the second cell 1B. For example, if the terminal equipment 103 in the idle state receives and saves the MIB information and SIB information of the second cell transmitted by the first cell, detects the reference signal of the second cell and obtains synchronization with the second cell via the first cell, it may camp on the second cell.

The terminal equipment 103 may obtain an identifier of the second cell 1B by detecting the reference signal of the second cell 1B, and determine whether the master information block (MIB) information and/or system information block (SIB) information of the second cell 1B is/are saved according to the obtained identifier of the second cell 1B.

If the terminal equipment in the connected state is to be handed over to the second cell 1B and is able to initiate services in the second cell 1B, it needs to obtain the master information block (MIB) information and/or system information block (SIB) information of the second cell 1B in addition to obtaining synchronization with the second cell 1B.

In at least one embodiment, the master information block (MIB) information and/or system information block (SIB) information of the second cell 1B is/are carried by a dedicated radio resource control (RRC) message of the first cell 1A.

In one example, the terminal equipment 103 receives master information block (MIB) information and/or system information block (SIB) information of one or more second cells 1B via the dedicated RRC message, and the terminal equipment 103 applies the received master information block (MIB) information and/or system information block (SIB) information of the second cell. Thus, the terminal equipment may be handed over to the second cell and initiate services in the second cell.

The dedicated RRC message is used for at least one of the following applications:
configuring a primary cell (PCell) of the terminal equipment 103 as the second cell 1B;
configuring a primary secondary cell (PScell) of the terminal equipment 103 as the second cell 1B;
updating an access layer key of a primary cell group when the second cell 1B is used as a PCell; or
updating an access layer key of a secondary cell group when the second cell 1B is used as a PScell.

In at least one embodiment, the reference signal of the second cell 1B includes a primary synchronization signal (PSS) and a secondary synchronization signal (SSS) of the second cell 1B, wherein the primary synchronization signal (PSS) and the secondary synchronization signal (SSS) occupy one symbol respectively.

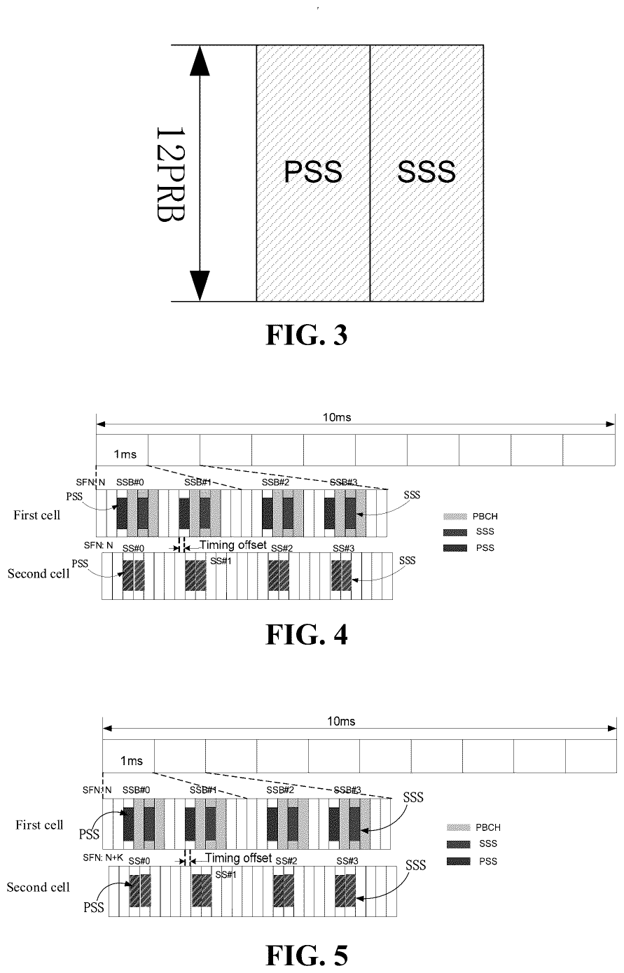

In operation 202, the terminal equipment detects the reference signal of the second cell. FIG. 3 is a schematic diagram of the reference signal of the second cell. As shown in FIG. 3, the PSS and SSS may be composed of two continuous or discontinuous orthogonal frequency division multiplexing (OFDM) symbols, such as occupying 12 physical resource blocks (PRBs). A position of the PSS may be identical to a position of a synchronization signal (SS) in normally transmitting a synchronization signal block (SSB). Or, positions of the PSS and SSS may be identical to a position of an SS in the SSB, which may reduce a complexity of the terminal equipment 103 in performing blind detection on reference signals. The SSB may include a PSS/SSS and a physical broadcast channel (PBCH).

In operation 202 in FIG. 2, by detecting the reference signal of the second cell, the terminal equipment 103 may detect a physical cell identifier (PCI) of the second cell 1B.

In addition, the reference signal of the second cell 1B may also include a downlink demodulation reference signal (DMRS), and the terminal equipment may detect a reference signal index of the second cell via the DMRS.

As shown in FIG. 2, in operation 204 in FIG. 2, the terminal equipment 103 receives a synchronization signal block (SSB) of the first cell 1A transmitted by the first cell 1A; and in operation 205, frame synchronization and timing synchronization with the first cell 1A are obtained according to the synchronization signal block (SSB) of the first cell 1A.

With the operations 204 and 205, the UE may obtain frame synchronization and timing synchronization with the first cell 1A, and obtain frame synchronization information of the first cell 1A.

In addition, as shown in FIG. 2, in operation 206, the terminal equipment 103 receives indication information, transmitted by the first cell 1A for indicating whether the first cell 1A and the second cell 1B are in frame synchronization.

When the indication information in operation 206 indicates that the first cell 1A and the second cell 1B are in frame synchronization, in order to obtain synchronization with the second cell 1B, the terminal equipment 103 obtains the frame synchronization information of the second cell 1B via the obtained frame synchronization information of the first cell 1A, so as to obtain synchronization with the second cell. The frame synchronization information includes a system frame number (SFN) and/or a half-frame indicator.

In operation 203, when the first cell 1A and the second cell 1B are in frame synchronization, the terminal equipment 103 may obtain synchronization with the second cell 1B in modes as follows:
mode 1.1: obtaining frame synchronization and timing synchronization with the second cell by the terminal equipment 103 according to a time-domain position of the synchronization signal block (SSB) of the first cell 1A, an index of the synchronization signal block (SSB) of the first cell 1A and a time-domain position of the reference signal of the second cell 1B; and
mode 1.2: obtaining a first index of the reference signal by the terminal equipment 103 from the reference signal of the second cell 1B, and obtaining the frame synchronization and timing synchronization of the second cell according to the first index, the time-domain position of the reference signal of the second cell 1B and the time-domain position of the SSB of the first cell 1A.

In the case where the indication information in operation 206 indicates that the first cell 1A and the second cell 1B are not in frame synchronization, in order to obtain synchronization with the second cell 1B, the terminal equipment 103 obtains frame synchronization information with the second cell 1B via the obtained frame synchronization information of the first cell 1A and frame synchronization offset information between the first cell 1A and the second cell 1A obtained from the first cell 1A. The first cell 1A may transmit the frame synchronization offset information with the second cell 1B via a system broadcast message (such as SIB1) or an RRC message. The frame synchronization offset information includes a frame number offset, or includes a frame number offset and a half-frame offset, wherein a value of the half-frame offset may be 0 or 1, which are respectively used to indicate that a timing deviation between the first cell 1A and the second cell 1B is within half a frame or exceeds half a frame. The frame synchronization offset information includes: a frame number offset, or a frame number offset and a half-frame offset. In addition, the terminal equipment 103 may obtain the frame synchronization information with the second cell 1B according to the frame synchronization information and frame synchronization offset information of the first cell 1A, wherein the frame synchronization information includes a system frame number (SFN) and/or a half-frame indicator.

In operation 203, if the first cell 1A and the second cell 1B are not in frame synchronization, the terminal equipment 103 may obtain synchronization with the second cell 1B in modes as follows:
mode 2.1: obtaining frame synchronization and timing synchronization with the second cell by the terminal equipment 103 according to the time-domain position of the synchronization signal block (SSB) of the first cell, the index of the synchronization signal block (SSB) of the first cell and the time-domain position of the reference signal of the second cell; and
mode 2.2: obtaining a second index of the reference signal by the terminal equipment 103 from the reference signal of the second cell 1B, and obtaining the frame synchronization and timing synchronization of the second cell according to the second index, the time-domain position of the reference signal of the second cell 1B and the time-domain position of the SSB of the first cell 1A.

Modes 1.1, 1.2, 2.2 and 2.2 shall be described below by way of examples.

When the first cell 1A and the second cell 1B are in frame synchronization, the terminal equipment 103 may obtain frame synchronization and timing synchronization with the second cell in mode 1.1 or 1.2.

Mode 1.1:
obtaining frame synchronization and timing synchronization with an NR cell by the terminal equipment 103 according to an SSB index of a first cell, a time-domain position of an SSB of a reference cell and a time-domain position of an SS of the NR cell.

Specifically, the terminal equipment 103 may deem that the index of the reference signal of the second cell 1B which is closest to the time-domain position of the SSB of the first cell 1A (i.e. an offset therebetween is smallest) is consistent with the index of the SSB of the first cell 1A. And in a case where the first cell is in frame number synchronization with the second cell, it may be deemed that the reference signal of second cell 1B which is closest to the time-domain position of the SSB of first cell 1A is located in a wireless frame having the same number as the SSB of the first cell 1A, thereby completing frame synchronization with the second cell 1B.

FIG. 4 is a schematic diagram of a synchronization relationship between the first cell and the second cell. In FIG. 4, the first cell and second cell are in frame synchronization. A subcarrier spacing between the first cell and second cell in FIG. 4 is 15 KHz; however, the subcarrier spacing between the first cell and second cell is not limited in the embodiment of this disclosure. It should be noted that the embodiment of this disclosure is also applicable to other values of subcarrier spacings between the first cell and second cell. As shown in FIG. 4, if the terminal equipment 103 detects that SSB #1 of the first cell 1A in frame number N is closest to a time-domain position of a searched or detected reference signal of the second cell 1B, it determines that the searched or detected reference signal of the second cell 1B is SS #1 which is also located in frame N.

The terminal equipment 103 may obtain an offset between a starting position of a wireless frame with an SFN that is N of the first cell 1A and a starting position of a wireless frame with an SFN that is also N of the second cell 1B from an offset between the SSB of the first cell 1A and the reference signal of the second cell 1B with identical indices, thereby obtaining the timing synchronization of the second cell 1B, that is, obtaining a starting position of a frame of the second cell 1B; or, the terminal equipment 103 may directly obtain the starting position of the frame of the second cell 1B from the index of the reference signal of the second cell 1B and a position of the reference signal in the wireless frame.

In mode 1.1, the timing offset between the first cell 1A and the second cell 1B (such as the timing offset in FIG. 4) is of a symbol level, for example, the timing offset should not exceed a half of a time-domain distance between two SSBs.

Mode 1.2:

The terminal equipment 103 obtains the frame and timing synchronization of the second cell via the index of the reference signal of the second cell 1B, the time-domain position of the reference signal of the second cell 1B and the time-domain position of the SSB of the first cell 1A.

Specifically, the terminal equipment 103 obtains a reference signal index by detecting the index of the reference signal of the second cell 1B, and the terminal equipment 103 may deem that SSBs of the first cell 1A with identical index numbers which are closest to the time-domain position of the reference signal of the second cell 1B and the reference signal of the second cell 1B belong to identical half-frames of the same wireless frame. As shown in FIG. 4, the terminal equipment 103 detects that the index of the reference signal of the second cell 1B is SS #1, and SSB #1 of the first cell 1A with the same sequence number which is closest to the position of the reference signal is located in the former half of frame N. Hence, the terminal equipment 103 deems that the detected SS #1 is also located in the first half of frame N, and obtains frame synchronization with the second cell 1B.

Thereafter, the terminal equipment 103 may obtain a frame starting time position of the second cell 1B according to the position of the reference signal in the half-frame, that is, obtaining the timing synchronization of the second cell 1B.

In mode 1.2, the timing offset between the first cell 1A and the second cell 1B should not exceed half a wireless frame (e.g. 5 ms).

When the first cell 1A and the second cell 1B are not in frame synchronization, the terminal equipment 103 may obtain the frame synchronization and timing synchronization with the second cell in mode 2.1 or 2.2.

Mode 2.1: obtaining the frame synchronization and timing synchronization with the second cell 1B according to the index of the SSB of the first cell 1A, the time-domain position of the SSB of the first cell 1A and the time-domain position of the SS of the second cell 1B.

Specifically, the terminal equipment 103 may determine that the index of the reference signal of the second cell 1B which is closest to the time-domain position of the SSB of the first cell 1A (i.e. an offset therebetween is smallest) is consistent with the index of the SSB of the first cell 1A. The SSB differs from a wireless frame number to which the reference signal of the second cell 1B belongs by K (i.e. a frame number offset is K), and then it is determined according to a half-frame offset that the SSB and the reference signal of the second cell 1B are located in identical or different half-frames, thereby completing frame synchronization with the second cell 1B.

FIG. 5 is another schematic diagram of the synchronization relationship between the first cell and the second cell. In FIG. 5, a subcarrier spacing between the first cell and second cell is 15 KHz; however, the subcarrier spacing between the first cell and second cell is not limited in the embodiment of this disclosure. It should be noted that the embodiment of this disclosure is also applicable to other values of subcarrier spacings between the first cell and second cell. As shown in FIG. 5, if the terminal equipment 103 finds that SSB #1 of the first cell 1A in frame number N is closest to a time-domain position of a searched or detected reference signal of the second cell 1B, it determines that an index of the searched or detected reference signal of the second cell 1B is #1 and it is also located in a frame with a frame number N+K; in addition, according to that the half-frame offset is 0, it may be determined that SS #1 is also located in the former half of the frame; however, if the half-frame offset is 1, it may be determined that SS #1 is located in the latter half of the frame.

The terminal equipment 103 may obtain an offset between a starting position of a wireless frame with an SFN that is N of the first cell 1A and a starting position of a wireless frame with an SFN that is also N of the second cell 1B from the offset between the SSB of the first cell 1A and the reference signal of the second cell 1B with identical indices, thereby obtaining the timing synchronization of the second cell 1B, that is, obtaining a starting position of a frame of the second cell 1B; or, the terminal equipment 103 may obtain the starting position of the frame of the second cell 1B from the index of the reference signal of the second cell 1B and a position of the reference signal in the wireless frame.

In mode 2.1, the timing offset between the first cell 1A and the second cell 1B (such as the timing offset in FIG. 5) is of a symbol level, for example, the timing offset should not exceed a half of a time-domain distance between two SSBs. Furthermore, in mode 2.1, the above frame synchronization offset information needs only to include frame number offset.

Mode 2.2: the terminal equipment 103 obtains the frame synchronization and timing synchronization with the second cell 1B from the index of the reference signal of the second cell 1B, the time-domain position of the reference signal of the second cell 1B and the time-domain position of the SSB of the first cell 1A.

Specifically, the terminal equipment 103 obtains the index of the reference signal by detecting the index of the reference signal of the second cell 1B. The terminal equipment 103 may determine that the SSB of the first cell 1A which is closest to the time-domain position of the reference signal of the second cell 1B differs from a wireless frame number to which the reference signal of the second cell 1B belongs by K (i.e. a frame number offset is K), and then determines according to a half-frame offset that they are located in identical or different half-frames. As shown in FIG. 5, if the terminal equipment 103 detects that index of the reference signal of the second cell 1B is SS #1 and SSB #1 of the first cell 1A with an identical sequence number which is closest to the position of the reference signal is located in frame N, it deems that the detected SS #1 is located in frame N+K. According to that the half-frame offset is 0, it may be deemed that SS #1 is also located in the former half of the frame, so as to obtain frame synchronization with the second cell 1B; however, if the half-frame offset is 1, it may be determined that SS #1 is located in the latter half of the frame.

The terminal equipment 103 obtains the timing synchronization of the second cell 1B by obtaining the frame starting time position of the second cell 1B according to the position of the reference signal in the half-frame.

In mode 2.2, when the frame synchronization offset information does not include the half-frame offset, the timing offset between the first cell 1A and the second cell 1B should not exceed half a wireless frame (e.g. 5 ms).

### Implementation 2

In implementation 2, the second cell 1B does not transmit MIB (RRC message) information and SIB1, but transmits a reference signal and a PBCH payload (physical layer information). The PBCH payload includes the system frame number (SFN) and/or the half-frame indicator and/or the index of the reference signal of the second cell 1B.

As shown in FIG. 2, Implementation 2 may include operations 201, 202 and 203.

In operation 201, the terminal equipment receives the master information block (MIB) information and/or the system information block (SIB) information of the second cell transmitted by the first cell.

It the terminal equipments in the idle state or inactive state is to select and camp on the second cell 1B, it needs to obtain the master information block (MIB) information and/or the system information block (SIB) information of the second cell 1B in addition to obtaining synchronization of the second cell 1B.

In at least one embodiment, the master information block (MIB) information and/or the system information block (SIB) information of the second cell 1B is/are carried by a system broadcast message of the first cell 1A, such as by SIB1 of the first cell 1A.

In one example, the terminal equipment 103 may receive master information block (MIB) information and/or system information block (SIB) information of one or more second cells from the system broadcast message of the first cell 1A, thereby enabling the terminal equipment to select and camp on the second cell. In addition, the terminal equipment 103 may store the master information block (MIB) information and/or system information block (SIB) information of one or more second cells 1B in a buffer, so that it may camp on the second cell 1B after detecting the reference signal of the second cell and synchronizing therewith.

In at least one embodiment, after the terminal equipment obtains synchronization with the second cell 1B, it may determine whether the master information block (MIB) information and/or system information block (SIB) information of the second cell 1B is/are saved. If the terminal equipment 103 determines that the master information block (MIB) information and/or system information block (SIB) information of the second cell 1B is/are saved, the terminal equipment 103 may camp on the second cell 1B. For example, if the terminal equipment 103 in the idle state receives and saves the MIB information and SIB information of the second cell transmitted by the first cell, detects the reference signal of the second cell and obtains synchronization with the second cell via the first cell, it may camp on the second cell.

The terminal equipment 103 may obtain an identifier of the second cell 1B by detecting the reference signal of the second cell 1B, and determine whether the master information block (MIB) information and/or system information block (SIB) information of the second cell 1B is/are saved according to the obtained identifier of the second cell 1B.

If the terminal equipment in the connected state is to be handed over to the second cell 1B and is able to initiate services in the second cell 1B, it needs to obtain the master information block (MIB) information and/or system information block (SIB) information of the second cell 1B in addition to obtaining synchronization with the second cell 1B.

In at least one embodiment, the master information block (MIB) information and/or system information block (SIB) information of the second cell 1B is/are carried by a dedicated radio resource control (RRC) message of the first cell 1A.

In one example, the terminal equipment 103 receives master information block (MIB) information and/or system information block (SIB) information of one or more second cells 1B via the dedicated RRC message, and the terminal equipment 103 applies the received master information block (MIB) information and/or system information block (SIB) information of the second cell. Thus, the terminal equipment may be handed over to the second cell and initiate services in the second cell.

The dedicated RRC message is used for at least one of the following applications:
configuring a primary cell (PCell) of the terminal equipment 103 as the second cell 1B;
configuring a primary secondary cell (PScell) of the terminal equipment 103 as the second cell 1B;
updating an access layer key of a primary cell group when the second cell 1B is used as a PCell; or
updating an access layer key of a secondary cell group when the second cell 1B is used as a PScell.

In operation 202, the terminal equipment detects the reference signal of the second cell. In Implementation 2, the reference signal of the second cell 1B may include a primary synchronization signal (PSS) and a secondary synchronization signal (SSS).

In some embodiments, the reference signal and physical broadcast channel (PBCH) payload of the second cell 1B occupy a total of 2 symbols, wherein the primary synchronization signal (PSS) and secondary synchronization signal (SSS) of the reference signal of the second cell 1B occupy one symbol respectively, and the physical broadcast channel (PBCH) payload is frequency division multiplexed with the primary synchronization signal (PSS) and secondary synchronization signal (SSS).

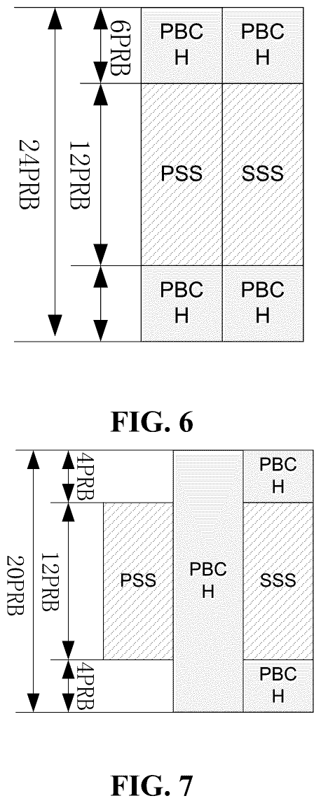

FIG. 6 is a schematic diagram of occupying two symbols by the reference signal and PBCH payload. As shown in FIG. 6, when the reference signal and PBCH payload occupy 2 OFDM symbols, bandwidths of the reference signal and PBCH payload are 20 PRBs, and a position of the PSS may be identical to a position of a synchronization signal (SS) transmitted by the second cell in normal operations, that is, it is identical to a position of the PSS in the SSB.

In some other embodiments, the reference signal and physical broadcast channel (PBCH) payload of the second cell 1B occupy a total of three symbol, wherein the primary synchronization signal (PSS) and secondary synchronization signal (SSS) of the reference signal of the second cell 1B occupy one symbol respectively, and the physical broadcast channel (PBCH) payload is also frequency division multiplexed or time division multiplexed with the primary synchronization signal (PSS) or secondary synchronization signal (SSS).

FIG. 7 is a schematic diagram of occupying total three symbols by the reference signal and PBCH payload. As shown in FIG. 7, when the reference signal and PBCH payload occupy 3 OFDM symbols, bandwidths of the reference signal and PBCH payload are identical to that of the SSB, which are all 20 PRBs. In addition, positions of the PSS and SSS may be identical to a position of a synchronization signal (SS) transmitted by the second cell in normal operations, that is, it is identical to a position of the PSS in the SSB. Thus, a complexity of blind detection by the terminal equipment 103 may be reduced.

In Implementation 2, the reference signal of the second cell 1B may further include a downlink demodulation reference signal (DMRS), wherein the DMRS is distributed on time-frequency resources of the PBCH payload. And the terminal equipment may detect the index of the reference signal of the second cell via the DMRS.

In operation 203, the terminal equipment 103 may obtain synchronization with the second cell 1B according to the reference signal and physical broadcast channel (PBCH) payload of the second cell 1B.

### Implementation 3

In Implementation 3, the second cell 1B does not transmit SIB1, but transmits a reference signal, a PBCH payload (physical layer information) and MIB information. The PBCH payload includes the system frame number (SFN) of the second cell 1B, and/or the half-frame indicator and/or the index of the reference signal.

As shown in FIG. 2, Implementation 3 may include operations 201, 202 and 203. In operation 201, the terminal equipment receives the master information block (MIB) information and/or system information block (SIB) information of the second cell transmitted by the first cell.

If the terminal equipment in an idle state or inactive state is to select and camp on the second cell 1B, it needs to obtain the master information block (MIB) information and/or system information block (SIB) information of the second cell 1B in addition to obtaining synchronization of the second cell 1B.

In at least one embodiment, the system information block (SIB) information of the second cell 1B is carried by a system broadcast message of the first cell 1A, such as by SIB1 of the first cell 1A.

In one example, the terminal equipment 103 may receive system information block (SIB) information of one or more second cells from the system broadcast message of the first cell 1A, thereby enabling the terminal equipment to select and camp on the second cell. In addition, the terminal equipment 103 may save the system information block (SIB) information of one or more second cells 1B in a buffer, so that it may camp on the second cell 1B after detecting the reference signal of the second cell and synchronizing therewith.

In at least one embodiment, after the terminal equipment obtains synchronization with the second cell 1B, it may determine whether the system information block (SIB) information of the second cell 1B is saved.

If the terminal equipment 103 determines that the system information block (SIB) information of the second cell 1B is saved, the terminal equipment 103 may camp on the second cell 1B. For example, if the terminal equipment 103 in the idle state receives and saves the SIB information of the second cell transmitted by the first cell, detects the reference signal of the second cell and obtains synchronization with the second cell via the first cell, it may camp on the second cell.

The terminal equipment 103 may obtain an identifier of the second cell 1B by detecting the reference signal of the second cell 1B, and determine whether the system information block (SIB) information of the second cell 1B is saved according to the obtained identifier of the second cell 1B.

If the terminal equipment in the connected state is to be handed over to the second cell 1B and is able to initiate services in the second cell 1B, it needs to obtain the system information block (SIB) information of the second cell 1B in addition to obtaining synchronization with the second cell 1B.

In at least one embodiment, the system information block (SIB) information of the second cell 1B is carried by a dedicated radio resource control (RRC) message of the first cell 1A.

In one example, the terminal equipment 103 receives system information block (SIB) information of one or more second cells 1B via the dedicated RRC message, and the terminal equipment 103 applies the received system information block (SIB) information of the second cell. Thus, the terminal equipment may be handed over to the second cell and initiate services in the second cell.

The dedicated RRC message is used for at least one of the following applications:
configuring a primary cell (PCell) of the terminal equipment 103 as the second cell 1B;
configuring a primary secondary cell (PScell) of the terminal equipment 103 as the second cell 1B;
updating an access layer key of a primary cell group when the second cell 1B is used as a PCell; or
updating an access layer key of a secondary cell group when the second cell 1B is used as a PScell.

In operation 202, the terminal equipment detects a reference signal of the second cell.

In at least one embodiment of Implementation 3, the reference signal, master information block (MIB) information and physical broadcast channel (PBCH) payload of the second cell 1B may be included in a non-cell defining synchronization signal block (SSB) transmitted by the second cell 1B. The second cell 1B may transmit the non-cell-defining SSB, but does not transmit a cell-defining synchronization signal block.

In operation 203 of Implementation 3, the terminal equipment 103 may obtain the frame synchronization and timing synchronization with the second cell 1B according to the reference signal, master information block (MIB) information and physical broadcast channel (PBCH) payload of the second cell 1B.

According to the embodiment of the first aspect of this disclosure, the terminal equipment 103 receives the master information block information and/or system information block information of the second cell 1B from the first cell 1A, and receives the reference signal of the second cell 1B from the second cell 1B. Therefore, the terminal equipment 103 is able to keep synchronization with the second cell and obtain the master information block information and/or system information block information of the second cell 1B, thereby ensuring that the UE may camp on the second cell normally, initiate services in the second cell or keep downlink synchronization with the second cell, avoiding service interruption and improving user experiences.

### Embodiment of a Second Aspect

At least addressed to the same issue as the embodiment of the first, the embodiment of the second aspect of this disclosure provides a method for transmitting a common signal, applicable to a network device, such as the network device 101 to which the first cell 1A belongs in FIG. 1.

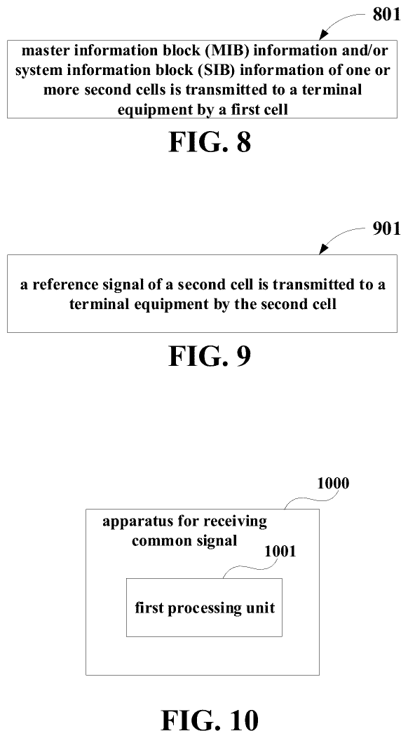

FIG. 8 is a schematic diagram of the method for transmitting a common signal of the embodiment of the second aspect of this disclosure. As shown in FIG. 8, the method includes:
operation 801: master information block (MIB) information and/or system information block (SIB) information of one or more second cells is transmitted to a terminal equipment by a first cell.

The terminal equipment is, for example, the terminal equipment 103 shown in FIG. 1.

In at least one embodiment, the terminal equipment 103 receives the master information block (MIB) information and/or system information block (SIB) information of one or more second cells 1B transmitted by a first cell 1A, and obtains synchronization with the second cell 1B according to a reference signal of the second cell 1B when the reference signal of the second cell 1B is detected.

In at least one embodiment, the master information block (MIB) information of the second cell includes at least one of the following:
a cell barring ID;
an intra-frequency cell reselection ID;
a subcarrier spacing between SIB1, msg2/4 and system information; or
position information of a demodulation reference signal (DMRS).

In at least one embodiment, the system information block (SIB) information of the second cell includes at least one of the following:
cell selection information;
cell access information;
system information (SI) scheduling information; or
access information based on a service category.

In at least one embodiment, the master information block (MIB) information and/or the system information block (SIB) information of the second cell is/are carried by a broadcast message of the first cell 1A or a dedicated RRC message.

The dedicated RRC message is used for at least one of the following applications:
configuring a primary cell (PCell) of the terminal equipment 103 as the second cell 1B;
configuring a primary secondary cell (PSCell) of the terminal equipment 103 as the second cell 1B;
updating an access layer key of a primary cell group when the second cell 1B is used as a PCell; or
updating an access layer key of a secondary cell group when the second cell 1B is used as a PScell.

In at least one embodiment, the network device 101 may further transmit a synchronization signal block (SSB) of the first cell 1A to the terminal equipment 103 via the first cell 1A.

In at least one embodiment, the network device 101 may further transmit to the terminal equipment indication information used for indicating whether timing of the first cell 1A and the second cell 1B is synchronized.

In at least one embodiment, in a case where the first cell 1A and the second cell 1B are not in frame synchronization (for example, the network device 101 transmits the indication information used for indicating whether timing of the first cell 1A and the second cell 1B is synchronized to the terminal equipment 103), the network device 101 may further transmit frame synchronization offset information of the first cell 1A and the second cell 1B to the terminal equipment 103, wherein the frame synchronization offset information includes a frame number offset, or a frame number offset and a half-frame offset. Hence, the terminal equipment 103 may obtain the synchronization with the second cell 1B according to the frame synchronization offset information and the reference information.

### Embodiment of a Third Aspect

At least addressed to the same issue as the embodiment of the first, the embodiment of the third aspect of this disclosure provides a method for transmitting a common signal, applicable to a network device, such as the network device 102 to which the second cell 1B belongs in FIG. 1.

FIG. 9 is a schematic diagram of the method for transmitting a common signal of the embodiment of the third aspect of this disclosure. As shown in FIG. 9, the method includes:
operation 901: a reference signal of a second cell is transmitted to a terminal equipment by the second cell.

The terminal equipment is, for example, the terminal equipment 103 shown in FIG. 1. Furthermore, the terminal equipment 103 receives master information block (MIB) information and/or system information block (SIB) information of the second cell 1B transmitted by a first cell 1A, and obtains synchronization with the second cell 1B according to the detected reference signal of the second cell 1B.

In Implementation 1, the network device 102 does not transmit master information block (MIB) information, system information block (SIB) information and a physical broadcast channel (PBCH) payload.

In at least one embodiment of Implementation 1, the reference signal of the second cell 1B includes a primary synchronization signal (PSS) and a secondary synchronization signal (SSS) of the second cell 1B, wherein the primary synchronization signal (PSS) and the secondary synchronization signal (SSS) occupy one symbol respectively. And furthermore, the reference signal of the second cell 1B includes a downlink demodulation reference signal (DMRS).

In Implementation 2, the network device 102 transmits not only a reference signal to the terminal equipment 103 via the second cell 1B, but also a physical broadcast channel (PBCH) payload of the second cell 1B to the terminal equipment 103 via the second cell 1B, wherein the PBCH payload includes a system frame number (SFN), and/or a half-frame indicator, and/or an index of the reference signal, of the second cell 1B.

In some embodiments of Implementation 2, the reference signal and the physical broadcast channel (PBCH) payload of the second cell occupy total two symbols.

For example, the reference signal of the second cell includes a primary synchronization signal (PSS) and a secondary synchronization signal (SSS), the primary synchronization signal (PSS) and the secondary synchronization signal (SSS) occupying one symbol respectively, and the physical broadcast channel (PBCH) payload being frequency-division multiplexed with the primary synchronization signal (PSS) and the secondary synchronization signal (SSS).

In some other embodiments of Implementation 2, the reference signal and the physical broadcast channel (PBCH) payload of the second cell occupy total three symbols.

For example, the reference signal of the second cell includes a primary synchronization signal (PSS) and a secondary synchronization signal (SSS), the primary synchronization signal (PSS) and the secondary synchronization signal (SSS) occupying one symbol respectively, and the physical broadcast channel (PBCH) payload being frequency-division multiplexed with the primary synchronization signal (PSS) or the secondary synchronization signal (SSS).

In Implementation 2, the reference signal of the second cell 1B further includes downlink demodulation reference signals (DMRSs), the DMRSs being distributed on time-frequency resources of the PBCH payload.

In Implementation 3, the network device 102 transmits not only a reference signal to the terminal equipment 103 via the second cell 1B, but also a physical broadcast channel (PBCH) payload of the second cell 1B and the master information block (MIB) information to the terminal equipment 103 via the second cell 1B, wherein the PBCH payload includes a system frame number (SFN), and/or a half-frame indicator, and/or an index of the reference signal, of the second cell 1B.

In at least one embodiment of Implementation 3, the reference signal, the master information block (MIB) information and the physical broadcast channel (PBCH) payload of the second cell 1B are included in a non-cell-defining SSB transmitted by the second cell 1B.

### Embodiment of a Fourth Aspect

The embodiment of the fourth aspect of this disclosure provides an apparatus for receiving a common signal, applicable to a terminal equipment, such as the terminal equipment 103 in FIG. 1. The apparatus corresponds to the method for receiving a common signal in the embodiment of the first aspect.

FIG. 10 is a schematic diagram of the apparatus for receiving a common signal of the embodiment of the fourth aspect of this disclosure. As shown in FIG. 10, an apparatus 1000 for receiving a common signal includes a first processing unit 1001.

The first processing unit 1001 performs the following operations:
receiving master information block (MIB) information and/or system information block (SIB) information of one or more second cells transmitted by a first cell;
detecting a reference signal of the second cell; and
obtaining synchronization with the second cell via the detected reference signal of the second cell.

In at least one embodiment, the master information block (MIB) information of the second cell includes at least one of the following:
a cell barring ID;
an intra-frequency cell reselection ID;
a subcarrier spacing for SIB1, msg2/4 and system information; or
position information of a demodulation reference signal (DMRS).

In at least one embodiment, the system information block (SIB) information of the second cell includes at least one of the following:
cell selection information;
cell access information;
system information (SI) scheduling information; or
access information based on a service category.

In at least one embodiment, the master information block (MIB) information and/or system information block (SIB) information of the second cell is/are carried by a system broadcast message of the first cell or a dedicated RRC message.

In at least one embodiment, the first processing unit receives the master information block (MIB) information and/or system information block (SIB) information of the one or more second cells via a system broadcast message of the first cell;
and the first processing unit further,
saves the master information block (MIB) information and/or system information block (SIB) information of the one or more second cells in a buffer.

In at least one embodiment,
the terminal equipment determines whether to save master information block (MIB) information and/or system information block (SIB) information of second cells after obtaining synchronization with the second cell;
and the first processing unit enables the terminal equipment to camp on the second cell if the terminal equipment saves the master information block (MIB) information and/or system information block (SIB) information of all the second cells.

In at least one embodiment, the dedicated RRC message is used for at least one of the following applications:
configuring a primary cell (PCell) of the terminal equipment as the second cell;
configuring a primary secondary cell (PScell) of the terminal equipment as the second cell;
updating an access layer key of a primary cell group when the second cell is used as a PCell; or
updating an access layer key of a secondary cell group when the second cell is used as a PScell.

In at least one embodiment, the first processing unit receives the master information block (MIB) information and/or the system information block (SIB) of the one or more second cells via the dedicated RRC message information;
and the first processing unit further applies the master information block (MIB) information and/or the system information block (SIB) information of the second cell.

In at least one embodiment, the reference signal of the second cell includes a primary synchronization signal (PSS) and a secondary synchronization signal (SSS) of the second cell, the primary synchronization signal (PSS) and the secondary synchronization signal (SSS) occupying one symbol respectively.

In at least one embodiment, the reference signal of the second cell further includes a downlink demodulation reference signal (DMRS).

In at least one embodiment,
the first processing unit receives a synchronization signal block (SSB) of the first cell transmitted by the first cell,
and obtains frame synchronization and timing synchronization with the first cell according to the synchronization signal block (SSB) of the first cell.

In at least one embodiment,
the first processing unit further receives indication information used for indicating whether timing of the first cell and the second cell is synchronized or not transmitted by the first cell.

In at least one embodiment, in a case where the first cell and the second cell are in frame synchronization,
the first processing unit further obtains frame synchronization information of the second cell according to frame synchronization information of the first cell, wherein the frame synchronization information includes a system frame number (SFN) and/or a half-frame indicator.

In at least one embodiment, the obtaining synchronization with the second cell via the detected reference signal of the second cell includes:
obtaining frame synchronization and timing synchronization with the second cell by the terminal equipment according to a time-domain position of the synchronization signal block (SSB) of the first cell, an index of the synchronization signal block (SSB) of the first cell and a time-domain position of the reference signal of the second cell.

In at least one embodiment, the obtaining synchronization with the second cell via the detected reference signal of the second cell includes:
obtaining a first index of the reference signal from the reference signal of the second cell; and
obtaining the frame synchronization and timing synchronization of the second cell according to the first index, the time-domain position of the reference signal of the second cell and a time-domain position of the SSB of the first cell.

In at least one embodiment, in a case where the first cell and the second cell are not in frame synchronization, the first processing unit further,
receives frame synchronization offset information of the first cell and the second cell transmitted by the first cell, the frame synchronization offset information including a frame number offset, or a frame number offset and a half-frame offset.

In at least one embodiment, the first processing unit further,
obtains frame synchronization information with the second cell according to the frame synchronization information of the first cell and the frame synchronization offset information, the frame synchronization information including a system frame number (SFN) and/or a half-frame indicator.

In at least one embodiment, the obtaining synchronization with the second cell via the detected reference signal of the second cell includes:
obtaining frame synchronization and timing synchronization with the second cell by the first processing unit according to a time-domain position of the synchronization signal block (SSB) of the first cell, an index of the synchronization signal block (SSB) of the first cell and a time-domain position of the reference signal of the second cell.

In at least one embodiment, the obtaining synchronization with the second cell via the detected reference signal of the second cell includes:
obtaining a second index of the reference signal from the reference signal of the second cell; and
obtaining frame synchronization and timing synchronization with the second cell according to the second index, a time-domain position of the reference signal of the second cell and a time-domain position of the SSB of the first cell.

In at least one embodiment, the master information block (MIB) information and the system information block (SIB) information of the second cell are carried by a broadcast message of the first cell or a dedicated RRC message,
and the first processing unit further receives a physical broadcast channel (PBCH) payload transmitted by the second cell, the PBCH payload including a system frame number (SFN), and/or a half-frame indicator, and/or an index of the reference signal, of the second cell.

In at least one embodiment, the reference signal and the physical broadcast channel (PBCH) payload of the second cell occupy total two symbols,
and the reference signal of the second cell includes a primary synchronization signal (PSS) and a secondary synchronization signal (SSS), the primary synchronization signal (PSS) and the secondary synchronization signal (SSS) occupying one symbol respectively, and the physical broadcast channel (PBCH) payload being frequency-division multiplexed with the primary synchronization signal (PSS) and the secondary synchronization signal (SSS).

In at least one embodiment, the reference signal and the physical broadcast channel (PBCH) payload of the second cell occupy total three symbols;
and the reference signal of the second cell includes a primary synchronization signal (PSS) and a secondary synchronization signal (SSS), the primary synchronization signal (PSS) and the secondary synchronization signal (SSS) occupying one symbol respectively, and the physical broadcast channel (PBCH) payload being further frequency-division multiplexed or time-division multiplexed with the primary synchronization signal (PSS) or the secondary synchronization signal (SSS).

In at least one embodiment, the reference signal of the second cell further includes downlink demodulation reference signals (DMRSs), the DMRSs being distributed on time-frequency resources of the PBCH payload.

In at least one embodiment, the obtaining synchronization with the second cell via the detected reference signal of the second cell includes:
obtaining synchronization with the second cell by the terminal equipment according to the reference signal and the physical broadcast channel (PBCH) payload of the second cell.

In at least one embodiment, the system information block (SIB) information of the second cell is carried by a broadcast message of the first cell or a dedicated RRC message;
and the first processing unit further receives master information block (MIB) information and a physical broadcast channel (PBCH) payload transmitted by the second cell,
wherein the PBCH payload includes a system frame number (SFN), and/or a half-frame indicator, and/or an index of the reference signal, of the second cell.

In at least one embodiment, the first processing unit receives the system information block (SIB) information of the one or more second cells via the system broadcast message of the first cell;
and the first processing unit further,
saves the system information block (SIB) information of the one or more second cells by the terminal equipment in a buffer.

In at least one embodiment,
determining by the first processing unit whether to save the system information block (SIB) information of the second cell after the terminal equipment obtains synchronization with the second cell; and
enabling the terminal equipment to camp on the second cell by the first processing unit if the terminal equipment saves the system information block (SIB) information of the second cell.

In at least one embodiment, the dedicated RRC message is used for one of the following applications:
configuring a primary cell (PCell) of the terminal equipment as the second cell;
configuring a primary secondary cell (PSCell) of the terminal equipment as the second cell;
updating an access layer key of a primary cell group when the second cell is used as a PCell; and
updating an access layer key of a secondary cell group when the second cell is used as a PScell.

In at least one embodiment, the first processing unit receives the system information block (SIB) information of the one or more second cells via the RRC message;
and the first processing unit further applies the system information block (SIB) information of the second cell.

In at least one embodiment, the reference signal, the master information block (MIB) information and the physical broadcast channel (PBCH) payload of the second cell are included in a non-cell-defining SSB transmitted by the second cell.

In at least one embodiment, the obtaining synchronization with the second cell via the detected reference signal of the second cell includes:
obtaining the synchronization with the second cell by the first processing unit according to the reference signal and the physical broadcast channel (PBCH) payload of the second cell.

### Embodiment of a Fifth Aspect

The embodiment of the fourth aspect of this disclosure provides an apparatus for transmitting a common signal, applicable to a network device, such as the network device 101 to which the first cell 1A belongs in FIG. 1. The apparatus corresponds to the method for transmitting a common signal in the embodiment of the second aspect.

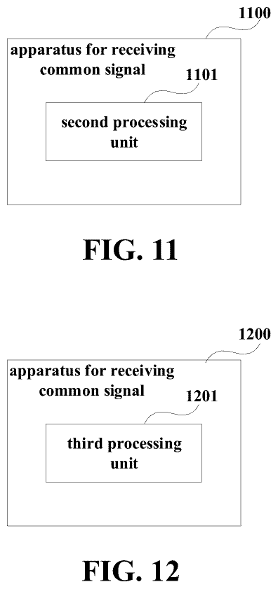

FIG. 11 is a schematic diagram of the apparatus for transmitting a common signal of the embodiment of the fifth aspect of this disclosure. As shown in FIG. 11, an apparatus 1100 for transmitting a common signal includes a second processing unit 1101 configured to perform the following operations:
transmitting master information block (MIB) information and/or system information block (SIB) information of one or more second cells by a first cell to a terminal equipment,
wherein when a reference signal of the second cell is detected, the terminal equipment obtains synchronization with the second cell according to the reference signal of the second cell.

In at least one embodiment, the master information block (MIB) information of the second cell includes at least one of the following:
a cell barring ID;
an intra-frequency cell reselection ID;
a subcarrier spacing between SIB1, msg2/4 and system information; or
position information of a demodulation reference signal (DMRS).

In at least one embodiment, the system information block (SIB) information of the second cell includes at least one of the following:
cell selection information;
cell access information;
system information (SI) scheduling information; or
access information based on a service category.

In at least one embodiment, the master information block (MIB) information and/or the system information block (SIB) information of the second cell is/are carried by a broadcast message of the first cell or a dedicated RRC message.

In at least one embodiment, the dedicated RRC message is used for at least one of the following applications:
configuring a primary cell (PCell) of the terminal equipment as the second cell;
configuring a primary secondary cell (PSCell) of the terminal equipment as the second cell;
updating an access layer key of a primary cell group when the second cell is used as a PCell; or
updating an access layer key of a secondary cell group when the second cell is used as a PScell.

In at least one embodiment, the second processing unit 1101 further transmits a synchronization signal block (SSB) of the first cell to the terminal equipment via the first cell.

In at least one embodiment, the second processing unit further,
transmits to the terminal equipment indication information used for indicating whether timing of the first cell and the second cell is synchronized.

In at least one embodiment, in a case where the first cell and the second cell are not in frame synchronization, the second processing unit further,
transmits frame synchronization offset information of the first cell and the second cell to the terminal equipment, the frame synchronization offset information including a frame number offset, or a frame number offset and a half-frame offset.

### Embodiment of a Sixth Aspect

The embodiment provides an apparatus for transmitting a common signal, applicable to a network device to which a second cell belongs, such as the network device 102 to which the second cell 1B belongs in FIG. 1. The apparatus for transmitting a common signal corresponds to the method for transmitting a common signal in the embodiment of the third aspect.

FIG. 12 is a schematic diagram of the apparatus for transmitting a common signal of the embodiment of the sixth aspect of this disclosure. As shown in FIG. 12, an apparatus 1200 for transmitting a common signal includes a third processing unit 1201 configured to perform the following operations:
transmitting a reference signal of a second cell to a terminal equipment via the second cell,
wherein the terminal equipment further receives master information block (MIB) information and/or system information block (SIB) information of the second cell transmitted by a first cell, and obtains synchronization with the second cell according to the detected reference signal of the second cell.

In at least one embodiment, the reference signal of the second cell includes a primary synchronization signal (PSS) and a secondary synchronization signal (SSS) of the second cell, the primary synchronization signal (PSS) and the secondary synchronization signal (SSS) occupying one symbol respectively.

In at least one embodiment, the reference signal of the second cell further includes a downlink demodulation reference signal (DMRS).

In at least one embodiment, the third processing unit further transmits a physical broadcast channel (PBCH) payload of the second cell to the terminal equipment via the second cell, the PBCH payload including a system frame number (SFN), and/or a half-frame indicator, and/or an index of the reference signal, of the second cell.

In at least one embodiment, the reference signal and the physical broadcast channel (PBCH) payload of the second cell occupy total two symbols,
and the reference signal of the second cell includes a primary synchronization signal (PSS) and a secondary synchronization signal (SSS), the primary synchronization signal (PSS) and the secondary synchronization signal (SSS) occupying one symbol respectively, and the physical broadcast channel (PBCH) payload being frequency-division multiplexed with the primary synchronization signal (PSS) and the secondary synchronization signal (SSS).

In at least one embodiment, the reference signal and the physical broadcast channel (PBCH) payload of the second cell occupy total three symbols;
and the reference signal of the second cell includes a primary synchronization signal (PSS) and a secondary synchronization signal (SSS), the primary synchronization signal (PSS) and the secondary synchronization signal (SSS) occupying one symbol respectively, and the physical broadcast channel (PBCH) payload being frequency-division multiplexed with the primary synchronization signal (PSS) or the secondary synchronization signal (SSS).

In at least one embodiment, the reference signal of the second cell further includes downlink demodulation reference signals (DMRSs), the DMRSs being distributed on time-frequency resources of the PBCH payload.

In at least one embodiment, the third processing unit further,
transmits the master information block (MIB) information and physical broadcast channel (PBCH) payload of the second cell to the terminal equipment via the second cell, the PBCH payload including a system frame number (SFN), and/or a half-frame indicator, and/or an index of the reference signal, of the second cell.

In at least one embodiment, the reference signal, the master information block (MIB) information and the physical broadcast channel (PBCH) payload of the second cell are included in a non-cell-defining SSB transmitted by the second cell.

### Embodiment of a Seventh Aspect

The embodiment of this disclosure provides a communication system, including a network device to which a first cell belongs, a network device to which a second cell belongs, and a terminal equipment, wherein the network device to which the first cell belongs and the network device to which the second cell belongs may be in the same structures of a network device.

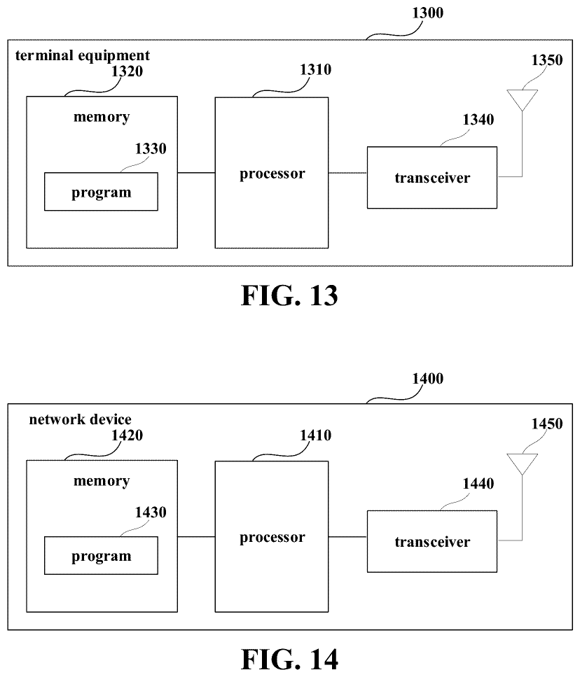

FIG. 13 is a schematic diagram of the terminal equipment of the embodiment of the seventh aspect of this disclosure, which may be used for the terminal equipment 103 shown in FIG. 1.

As shown in FIG. 13, a terminal equipment 1300 may include a processor 1310 (such as a central processing unit (CPU)) and a memory 1320, the memory 1320 being coupled to the processor 1310. The memory 1320 may store various data, and furthermore, it may store a program 1330 for information processing, and execute the program 1330 under control of the processor 1310.

For example, the processor 1310 may be configured to execute a program to carry out the method as described in the embodiment of the first aspect.

Furthermore, as shown in FIG. 13, the terminal equipment 1300 may include a transceiver 1340, and an antenna 1350, etc. Functions of the above components are similar to those in the related art, and shall not be described herein any further. It should be noted that the terminal equipment 1300 does not necessarily include all the parts shown in FIG. 13, and furthermore, the terminal equipment 1300 may include parts not shown in FIG. 13, and the related art may be referred to.

FIG. 14 is a schematic diagram of the network device of the embodiment of the seventh aspect of this disclosure. The network device shown in FIG. 14 may be used for the network device 101 and/or the network device 102 shown in FIG. 1.

As shown in FIG. 14, a network device 1400 may include a processor 1410 (such as a central processing unit (CPU)) and a memory 1420, the memory 1420 being coupled to the processor 1410. The memory 1420 may store various data, and furthermore, it may store a program 1430 for information processing, and execute the program 1430 under control of the processor 1410.

For example, the processor 1410 may be configured to execute a program to carry out the method as described in the embodiment of the second or third aspect.

Furthermore, as shown in FIG. 14, the network device 1400 may include a transceiver 1440, and an antenna 1450, etc. Functions of the above components are similar to those in the related art, and shall not be described herein any further. It should be noted that the network device 1400 does not necessarily include all the parts shown in FIG. 14, and furthermore, the network device 1400 may include parts not shown in FIG. 14, and the related art may be referred to.

An embodiment of this disclosure provides a computer readable program, which, when executed in a terminal equipment, causes the terminal equipment to carry out the method as described in the embodiment of the first aspect.

An embodiment of this disclosure provides a computer storage medium, including a computer readable program, which causes a terminal equipment to carry out the method as described in the embodiment of the first aspect.

An embodiment of this disclosure provides a computer readable program, which, when executed in a network device, causes the network device to carry out the method as described in the embodiment of the second or third aspect.

An embodiment of this disclosure provides a computer storage medium, including a computer readable program, which causes a network device to carry out the method as described in the embodiment of the second or third aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. A method for receiving a common signal, including:
receiving, by a terminal equipment, master information block (MIB) information and/or system information block (SIB) information of one or more second cells transmitted by a first cell;
detecting a reference signal of the second cell by the terminal equipment; and
obtaining synchronization with the second cell by the terminal equipment via the detected reference signal of the second cell.

2. The method according to supplement 1, wherein the master information block (MIB) information of the second cell includes at least one of the following:
a cell barring ID;
an intra-frequency cell reselection ID;
a subcarrier spacing for SIB1, msg2/4 and system information; or
position information of a demodulation reference signal (DMRS).

3. The method according to supplement 1, wherein the system information block (SIB) information of the second cell includes at least one of the following:
cell selection information;
cell access information;
system information (SI) scheduling information; or
access information based on a service category.

4. The method according to supplement 1, wherein the master information block (MIB) information and/or system information block (SIB) information of the second cell is/are carried by a system broadcast message of the first cell or a dedicated RRC message.

5. The method according to supplement 4, wherein the terminal equipment receives the master information block (MIB) information and/or system information block (SIB) information of the one or more second cells via a system broadcast message of the first cell;
and the method further includes:
saving the master information block (MIB) information and/or system information block (SIB) information of the one or more second cells in a buffer by the terminal equipment.

6. The method according to supplement 5, wherein the method further includes:
determining by the terminal equipment whether to save master information block (MIB) information and/or system information block (SIB) information of second cells after obtaining synchronization with the second cell; and
camping on the second cell by the terminal equipment if the terminal equipment saves the master information block (MIB) information and/or system information block (SIB) information of all the second cells.

7. The method according to supplement 4, wherein the dedicated RRC message is used for at least one of the following applications:
configuring a primary cell (PCell) of the terminal equipment as the second cell;
configuring a primary secondary cell (PScell) of the terminal equipment as the second cell;
updating an access layer key of a primary cell group when the second cell is used as a PCell; or
updating an access layer key of a secondary cell group when the second cell is used as a PScell.

8. The method according to supplement 7, wherein the terminal equipment receives the master information block (MIB) information and/or the system information block (SIB) of the one or more second cells via the dedicated RRC message information;
and the terminal equipment applies the master information block (MIB) information and/or the system information block (SIB) information of the second cell.

9. The method according to supplement 4, wherein the reference signal of the second cell includes a primary synchronization signal (PSS) and a secondary synchronization signal (SSS) of the second cell, the primary synchronization signal (PSS) and the secondary synchronization signal (SSS) occupying one symbol respectively.

10. The method according to supplement 9, wherein the reference signal of the second cell further includes a downlink demodulation reference signal (DMRS).

11. The method according to any one of supplements 4-10, wherein the method further includes:
receiving, by the terminal equipment, a synchronization signal block (SSB) of the first cell transmitted by the first cell; and
obtaining frame synchronization and timing synchronization with the first cell according to the synchronization signal block (SSB) of the first cell.

12. The method according to any one of supplements 4-11, wherein the method further includes:
receiving, by the terminal equipment, indication information used for indicating whether timing of the first cell and the second cell is synchronized or not transmitted by the first cell.

13. The method according to supplement 11 or 12, wherein in a case where the first cell and the second cell are in frame synchronization, the method further includes:
obtaining, by the terminal equipment, frame synchronization information of the second cell according to frame synchronization information of the first cell,
wherein the frame synchronization information includes a system frame number (SFN) and/or a half-frame indicator.

14. The method according to supplement 13, wherein the obtaining synchronization with the second cell via the detected reference signal of the second cell includes:
obtaining frame synchronization and timing synchronization with the second cell by the terminal equipment according to a time-domain position of the synchronization signal block (SSB) of the first cell, an index of the synchronization signal block (SSB) of the first cell and a time-domain position of the reference signal of the second cell.

15. The method according to supplement 13, wherein the obtaining synchronization with the second cell via the detected reference signal of the second cell includes:
obtaining a first index of the reference signal from the reference signal of the second cell; and
obtaining the frame synchronization and timing synchronization of the second cell according to the first index, the time-domain position of the reference signal of the second cell and a time-domain position of the SSB of the first cell.

16. The method according to supplement 11 or 12, wherein in a case where the first cell and the second cell are not in frame synchronization, the method further includes:
receiving frame synchronization offset information of the first cell and the second cell transmitted by the first cell, the frame synchronization offset information including a frame number offset, or a frame number offset and a half-frame offset.

17. The method according to supplement 16, wherein the method further includes:
obtaining frame synchronization information with the second cell by the terminal equipment according to the frame synchronization information of the first cell and the frame synchronization offset information, the frame synchronization information including a system frame number (SFN) and/or a half-frame indicator.

18. The method according to supplement 17, wherein the obtaining synchronization with the second cell via the detected reference signal of the second cell includes:
obtaining frame synchronization and timing synchronization with the second cell by the terminal equipment according to a time-domain position of the synchronization signal block (SSB) of the first cell, an index of the synchronization signal block (SSB) of the first cell and a time-domain position of the reference signal of the second cell.

19. The method according to supplement 17, wherein the obtaining synchronization with the second cell via the detected reference signal of the second cell includes:
obtaining a second index of the reference signal from the reference signal of the second cell; and
obtaining frame synchronization and timing synchronization with the second cell according to the second index, a time-domain position of the reference signal of the second cell and a time-domain position of the SSB of the first cell.

20. The method according to any one of supplements 1-8, wherein the master information block (MIB) information and the system information block (SIB) information of the second cell are carried by a broadcast message of the first cell or a dedicated RRC message,
and the terminal equipment further receives a physical broadcast channel (PBCH) payload transmitted by the second cell, the PBCH payload including a system frame number (SFN), and/or a half-frame indicator, and/or an index of the reference signal, of the second cell.

21. The method according to supplement 20, wherein the reference signal and the physical broadcast channel (PBCH) payload of the second cell occupy total two symbols,
and the reference signal of the second cell includes a primary synchronization signal (PSS) and a secondary synchronization signal (SSS), the primary synchronization signal (PSS) and the secondary synchronization signal (SSS) occupying one symbol respectively, and the physical broadcast channel (PBCH) payload being frequency-division multiplexed with the primary synchronization signal (PSS) and the secondary synchronization signal (SSS).

22. The method according to supplement 20, wherein the reference signal and the physical broadcast channel (PBCH) payload of the second cell occupy total three symbols;
and the reference signal of the second cell includes a primary synchronization signal (PSS) and a secondary synchronization signal (SSS), the primary synchronization signal (PSS) and the secondary synchronization signal (SSS) occupying one symbol respectively, and the physical broadcast channel (PBCH) payload being further frequency-division multiplexed or time-division multiplexed with the primary synchronization signal (PSS) or the secondary synchronization signal (SSS).

23. The method according to supplement 20, wherein the reference signal of the second cell further includes downlink demodulation reference signals (DMRSs), the DMRSs being distributed on time-frequency resources of the PBCH payload.

24. The method according to any one of supplements 20-23, wherein the obtaining synchronization with the second cell via the detected reference signal of the second cell includes:
obtaining synchronization with the second cell by the terminal equipment according to the reference signal and the physical broadcast channel (PBCH) payload of the second cell.

25. The method according to any one of supplements 1-3, wherein the system information block (SIB) information of the second cell is carried by a broadcast message of the first cell or a dedicated RRC message;
and the terminal equipment further receives master information block (MIB) information and a physical broadcast channel (PBCH) payload transmitted by the second cell,
wherein the PBCH payload includes a system frame number (SFN), and/or a half-frame indicator, and/or an index of the reference signal, of the second cell.

26. The method according to supplement 25, wherein the terminal equipment receives the system information block (SIB) information of the one or more second cells via the system broadcast message of the first cell;
and the method further includes:
saving the system information block (SIB) information of the one or more second cells by the terminal equipment in a buffer.

27. The method according to supplement 26, wherein the method further includes:
determining by the terminal equipment whether to save the system information block (SIB) information of the second cell after obtaining synchronization with the second cell; and
camping on the second cell by the terminal equipment if the terminal equipment saves the system information block (SIB) information of the second cell.

28. The method according to supplement 25, wherein the dedicated RRC message is used for one of the following applications:
configuring a primary cell (PCell) of the terminal equipment as the second cell;
configuring a primary secondary cell (PSCell) of the terminal equipment as the second cell;
updating an access layer key of a primary cell group when the second cell is used as a PCell; or
updating an access layer key of a secondary cell group when the second cell is used as a PScell.

29. The method according to supplement 28, wherein the terminal equipment receives the system information block (SIB) information of the one or more second cells via the RRC message;
and the method further includes:
applying the system information block (SIB) information of the second cell by the terminal equipment.

30. The method according to any one of supplements 25-29, wherein the reference signal, the master information block (MIB) information and the physical broadcast channel (PBCH) payload of the second cell are included in a non-cell-defining SSB transmitted by the second cell.

31. The method according to any one of supplements 25-30, wherein the obtaining synchronization with the second cell via the detected reference signal of the second cell includes:
obtaining the synchronization with the second cell by the terminal equipment according to the reference signal and the physical broadcast channel (PBCH) payload of the second cell.

32. A method for transmitting a common signal, applicable to a network device to which a first cell belongs, the method including:
transmitting master information block (MIB) information and/or system information block (SIB) information of one or more second cells by a first cell to a terminal equipment, wherein when a reference signal of the second cell is detected, the terminal equipment obtains synchronization with the second cell according to the reference signal of the second cell.

33. The method according to supplement 32, wherein the master information block (MIB) information of the second cell includes at least one of the following:
a cell barring ID;
an intra-frequency cell reselection ID;
a subcarrier spacing between SIB1, msg2/4 and system information; or
position information of a demodulation reference signal (DMRS).

34. The method according to supplement 32, wherein the system information block (SIB) information of the second cell includes at least one of the following:
cell selection information;
cell access information;
system information (SI) scheduling information; or
access information based on a service category.

35. The method according to supplement 32, wherein the master information block (MIB) information and/or the system information block (SIB) information of the second cell is/are carried by a broadcast message of the first cell or a dedicated RRC message.

36. The method according to supplement 35, wherein the dedicated RRC message is used for at least one of the following applications:
configuring a primary cell (PCell) of the terminal equipment as the second cell;
configuring a primary secondary cell (PSCell) of the terminal equipment as the second cell;
updating an access layer key of a primary cell group when the second cell is used as a PCell; or
updating an access layer key of a secondary cell group when the second cell is used as a PScell.

37. The method according to supplement 35, wherein the method further includes:
transmitting a synchronization signal block (SSB) of the first cell to the terminal equipment via the first cell.

38. The method according to supplement 35, wherein the method further includes:
transmitting to the terminal equipment indication information used for indicating whether timing of the first cell and the second cell is synchronized.

39. The method according to supplement 38, wherein in a case where the first cell and the second cell are not in frame synchronization, the method further includes:
transmitting frame synchronization offset information of the first cell and the second cell to the terminal equipment, the frame synchronization offset information including a frame number offset, or a frame number offset and a half-frame offset.

40. A method for transmitting a common signal, applicable to a network device to which a second cell belongs, the method including:
transmitting a reference signal of a second cell to a terminal equipment via the second cell,
wherein the terminal equipment further receives master information block (MIB) information and/or system information block (SIB) information of the second cell transmitted by a first cell, and obtains synchronization with the second cell according to the detected reference signal of the second cell.

41. The method according to supplement 40, wherein the reference signal of the second cell includes a primary synchronization signal (PSS) and a secondary synchronization signal (SSS) of the second cell, the primary synchronization signal (PSS) and the secondary synchronization signal (SSS) occupying one symbol respectively.

42. The method according to supplement 41, wherein the reference signal of the second cell further includes a downlink demodulation reference signal (DMRS).

43. The method according to supplement 40, wherein the method further includes:
transmitting a physical broadcast channel (PBCH) payload of the second cell to the terminal equipment via the second cell, the PBCH payload including a system frame number (SFN), and/or a half-frame indicator, and/or an index of the reference signal, of the second cell.

44. The method according to supplement 43, wherein the reference signal and the physical broadcast channel (PBCH) payload of the second cell occupy total two symbols,
and the reference signal of the second cell includes a primary synchronization signal (PSS) and a secondary synchronization signal (SSS), the primary synchronization signal (PSS) and the secondary synchronization signal (SSS) occupying one symbol respectively, and the physical broadcast channel (PBCH) payload being frequency-division multiplexed with the primary synchronization signal (PSS) and the secondary synchronization signal (SSS).

45. The method according to supplement 43, wherein the reference signal and the physical broadcast channel (PBCH) payload of the second cell occupy total three symbols;
and the reference signal of the second cell includes a primary synchronization signal (PSS) and a secondary synchronization signal (SSS), the primary synchronization signal (PSS) and the secondary synchronization signal (SSS) occupying one symbol respectively, and the physical broadcast channel (PBCH) payload being frequency-division multiplexed with the primary synchronization signal (PSS) or the secondary synchronization signal (SSS).

46. The method according to supplement 43, wherein the reference signal of the second cell further includes downlink demodulation reference signals (DMRSs), the DMRSs being distributed on time-frequency resources of the PBCH payload.

47. The method according to supplement 40, wherein the method further includes:
transmitting the master information block (MIB) information and physical broadcast channel (PBCH) payload of the second cell to the terminal equipment via the second cell, the PBCH payload including a system frame number (SFN), and/or a half-frame indicator, and/or an index of the reference signal, of the second cell.

48. The method according to supplement 47, wherein the reference signal, the master information block (MIB) information and the physical broadcast channel (PBCH) payload of the second cell are included in a non-cell-defining SSB transmitted by the second cell.

What is claimed is:

1. An apparatus for receiving a common signal, applicable to a terminal equipment, the apparatus comprising processor circuitry configured to perform:
receiving master information block (MIB) information and/or system information block (SIB) information of one or more second cells transmitted by a first cell;
detecting a reference signal of the second cell; and
obtaining synchronization with the second cell via the detected reference signal of the second cell.

2. The apparatus according to claim 1, wherein the master information block (MIB) information of the second cell includes at least one of the following:
a cell barring ID;
an intra-frequency cell reselection ID;
a subcarrier spacing between SIB1, msg2/4 and system information; or
position information of a demodulation reference signal (DMRS).

3. The apparatus according to claim 1, wherein the system information block (SIB) information of the second cell includes at least one of the following:
cell selection information;
cell access information;
system information (SI) scheduling information; or
access information based on a service category.

4. The apparatus according to claim 1, wherein the master information block (MIB) information and/or system information block (SIB) information of the second cell is/are carried by a system broadcast message of the first cell or a dedicated RRC message.

5. The apparatus according to claim 4, wherein the processor circuitry receives the master information block (MIB) information and/or system information block (SIB) information of the one or more second cells via a system broadcast message of the first cell;
and the processor circuitry further saves the master information block (MIB) information and/or system information block (SIB) information of the one or more second cells.

6. The apparatus according to claim 5, wherein,
after the terminal equipment obtains synchronization with the second cell, the processor circuitry further determines whether to save the master information block (MIB) information and/or system information block (SIB) information of the second cell;
and the processor circuitry enables the terminal equipment to camp on the second cell if the terminal equipment saves the master information block (MIB) information and/or system information block (SIB) information of the second cell.

7. The apparatus according to claim 4, wherein the dedicated RRC message is used for at least one of the following:
configuring a primary cell (PCell) of the terminal equipment as the second cell;
configuring a primary secondary cell (PSCell) of the terminal equipment as the second cell;
updating an access layer key of a primary cell group when the second cell is used as a PCell; or
updating an access layer key of a secondary cell group when the second cell is used as a PScell.

8. The apparatus according to claim 4, wherein the reference signal of the second cell includes a primary synchronization signal (PSS) and a secondary synchronization signal (SSS) of the second cell, the primary synchronization signal (PSS) and the secondary synchronization signal (SSS) occupying one symbol respectively.

9. The apparatus according to claim 4, wherein the processor circuitry further,
receives a synchronization signal block (SSB) of the first cell transmitted by the first cell; and
obtains frame synchronization and timing synchronization with the first cell according to the synchronization signal block (SSB) of the first cell.

10. The apparatus according to claim 4, wherein the processor circuitry further,
receives indication information used for indicating whether timing of the first cell and the second cell is synchronized transmitted by the first cell.

11. The apparatus according to claim 9, wherein in a case where the first cell and the second cell are in frame synchronization, the processor circuitry further,
obtains frame synchronization information of the second cell according to frame synchronization information of the first cell, and
wherein the frame synchronization information includes a system frame number (SFN) and/or a half-frame indicator.

12. The apparatus according to claim 11, wherein the obtaining synchronization with the second cell via the detected reference signal of the second cell comprises:
obtaining frame synchronization and timing synchronization with the second cell by the processor circuitry according to a time-domain position of the synchronization signal block (SSB) of the first cell, an index of the synchronization signal block (SSB) of the first cell and a time-domain position of the reference signal of the second cell.

13. The apparatus according to claim 11, wherein the obtaining synchronization with the second cell via the detected reference signal of the second cell comprises:
obtaining a first index of the reference signal from the reference signal of the second cell; and
obtaining the frame synchronization and timing synchronization of the second cell according to the first index, the time-domain position of the reference signal of the second cell and a time-domain position of the SSB of the first cell.

14. The apparatus according to claim 9, wherein in a case where the first cell and the second cell are not in frame synchronization, the processor circuitry further,
receives frame synchronization offset information of the first cell and the second cell transmitted by the first cell, the frame synchronization offset information including a frame number offset, or a frame number offset and a half-frame offset.

15. The apparatus according to claim 14, wherein the processor circuitry further,
obtains frame synchronization information with the second cell according to the frame synchronization information of the first cell and the frame synchronization offset information, the frame synchronization information including a system frame number (SFN) and/or a half-frame indicator.

16. The apparatus according to claim 15, wherein the obtaining synchronization with the second cell via the detected reference signal of the second cell comprises:
obtaining frame synchronization and timing synchronization with the second cell by the processor circuitry according to a time-domain position of the synchronization signal block (SSB) of the first cell, an index of the synchronization signal block (SSB) of the first cell and a time-domain position of the reference signal of the second cell.

17. The apparatus according to claim 15, wherein the obtaining synchronization with the second cell via the detected reference signal of the second cell comprises:
obtaining a second index of the reference signal from the reference signal of the second cell; and
obtaining the frame synchronization and timing synchronization with the second cell according to the second index, a time-domain position of the reference signal of the second cell and a time-domain position of the SSB of the first cell.

18. The apparatus according to claims 1, wherein the master information block (MIB) information and the system information block (SIB) information of the second cell are carried by a broadcast message of the first cell or a dedicated RRC message,
and the processor circuitry further receives a physical broadcast channel (PBCH) payload transmitted by the second cell, the PBCH payload including a system frame number (SFN), and/or a half-frame indicator, and/or an index of the reference signal, of the second cell.

19. The apparatus according to claim 18, wherein the reference signal and the physical broadcast channel (PBCH) payload of the second cell occupy total two symbols,
and the reference signal of the second cell includes a primary synchronization signal (PSS) and a secondary synchronization signal (SSS), the primary synchronization signal (PSS) and the secondary synchronization signal (SSS) occupying one symbol respectively, and the physical broadcast channel (PBCH) payload being frequency-division multiplexed with the primary synchronization signal (PSS) and the secondary synchronization signal (SSS).

20. The apparatus according to claim 18, wherein the reference signal and the physical broadcast channel (PBCH) payload of the second cell occupy total three symbols;
and the reference signal of the second cell includes a primary synchronization signal (PSS) and a secondary synchronization signal (SSS), the primary synchronization signal (PSS) and the secondary synchronization signal (SSS) occupying one symbol respectively, and the physical broadcast channel (PBCH) payload being further frequency-division multiplexed or time-division multiplexed with the primary synchronization signal (PSS) or the secondary synchronization signal (SSS).
